(19) United States
(12) Patent Application Publication
(10) Pub. No.: US 2017/0203853 A1
(43) Pub. Date: Jul. 20, 2017

(54) LOCKING AND UNLOCKING MECHANISM

(71) Applicant: Hamilton Sundstrand Corporation, Charlotte, NC (US)

(72) Inventors: Piotr SOBOLAK, Stupsk (PL); Izabela PAWELEC, Wielun (PL)

(21) Appl. No.: 15/364,466

(22) Filed: Nov. 30, 2016

(30) Foreign Application Priority Data
Jan. 19, 2016 (EP) 16151850.1

(51) Int. Cl. B64D 41/00; G05G 5/00; E05B 47/06

(52) U.S. Cl. CPC B64D 41/007; E05B 47/0603; G05G 5/005

(57) ABSTRACT

A locking mechanism for releasably locking a lock bolt against axial movement includes a solenoid assembly arranged, in use, in proximity to an axially moveable lock bolt. The solenoid assembly includes: a solenoid, a solenoid bias spring and a solenoid plunger having a plunger tip. When the solenoid is energised, the bias spring causes the solenoid plunger to move to bring the plunger tip into locking engagement with the lock bolt to prevent axial movement thereof, and when the solenoid is not energised, the solenoid bias spring causes the solenoid plunger to move to bring the plunger tip out of locking engagement with the lock bolt thus permitting axial movement thereof.

### FOREIGN PRIORITY

This application claims priority to European Patent Application No. 16151850.1 filed Jan. 19, 2016, the entire contents of which is incorporated herein by reference.

### TECHNICAL FIELD

The present disclosure relates to locking/unlocking mechanisms for deployable components. The mechanism is particularly suitable as an unlocking mechanism for a ram air turbine (RAT) actuator but could also find application in other deployable or movable systems such as other actuators, valves, pumps and the like.

### BACKGROUND

Many systems and mechanisms are known in which a component is movable between a closed or stowed position and an open or deployed position, and wherein a component should be locked in the desired position and unlocked to permit movement between the positions. Particular examples are valves or actuators, such as RAT actuators as described in more detail below.

Locking mechanisms are known to secure the actuator, valve etc. in a particular position, and unlocking mechanisms are known to release the locking mechanism and permit movement of the actuator/valve components to a different position, whereupon the actuator components can then also be locked in the second position by means of a locking mechanism. A locking mechanism for a RAT actuator is disclosed, for example, in US 2013/0327207.

Ram air turbines are used in aircraft to provide electric and/or hydraulic power to components of the aircraft, for example in the event of failure of other electrical or hydraulic power generating equipment on board the aircraft. In normal operation of the aircraft, the RAT is housed within the aircraft, but when needed it is extended into the airflow around the aircraft such that it may turn, due to the airflow, and generates electrical and/or hydraulic power. The RAT is typically pivoted into position by means of an actuator, for example a hydraulic actuator. The actuator typically includes a lock bolt which extends to deploy the RAT. The actuator has a lock mechanism which prevents inadvertent movement of the lock bolt and, thus, inadvertent deployment of the RAT. The main locking mechanism typically comprises a spring loaded lock bolt which must be moved in an axial direction to unlock the actuator. Such an actuator is disclosed, for example, in US 2015/0232195. RAT actuators are also disclosed in U.S. Pat. No. 8,640,563, U.S. Pat. No. 9,193,472 and US 2015/0096437.

An unlocking mechanism is provided to permit the axial bolt movement. A conventional unlocking mechanism is shown, for example, in FIGS. 2A and 2B, comprising a linkage arrangement, one end of which is rotatably coupled to one end of the lock bolt and the other end of which is axially fixed and rotatably coupled to, for example, a mounting wall. A solenoid moves the link between a locked (FIG. 2A) and an unlocked (FIG. 2B) position. In the locked position, the linkage assembly pushes against the lock bolt against the force of the lock bolt spring to prevent axial movement of the lock bolt. When it is required to deploy the RAT, the lock bolt needs to be released for axial movement of the actuator. As seen in FIG. 2B, a pull force, greater than the spring force, is exerted on the linkage assembly by means of a solenoid, which moves the linkage assembly out of engagement with the lock bolt. This allows the lock bolt to move axially to initiate actuator unlocking to permit deployment. The solenoid must have sufficient force to displace the lock bolt against the force of the lock bolt spring and the linkages and joints require sufficient axial and radial space and may also be prone to wear or damage.

The size and weight of components is of particular concern in aircraft where there is a desire to use lighter and smaller components, whilst maintaining safety and reliability.

There is a desire, therefore, to provide a locking/unlocking mechanism for such systems to prevent/permit axial movement of a component such as a lock bolt, without the need for such large solenoids and a series of links.

### SUMMARY

The present invention provides a locking mechanism for releasably locking a lock bolt against axial movement, the mechanism comprising a solenoid assembly arranged, in use, in proximity to an axially moveable member such as a piston in moveable engagement with the lock bolt, the solenoid assembly comprising a solenoid, a solenoid bias member and a solenoid plunger having a plunger tip, wherein when the solenoid is in a first state of one of not energised or energised, the bias member causes the solenoid plunger to move to bring the plunger tip into locking engagement with the axially moveable member to prevent axial movement thereof, and when the solenoid is in a second opposite state being the other of energised or not energised, the solenoid bias member causes the solenoid plunger to move to bring the plunger tip out of locking engagement with the piston thus permitting axial movement thereof together with the lock bolt.

In a preferred embodiment, the mechanism comprises two such solenoid assemblies. The disclosure also provides an actuator assembly comprising a lock bolt and such a locking mechanism.

### BRIEF DESCRIPTION OF THE DRAWINGS

Preferred embodiments will now be described by way of example only and with reference to the accompanying drawings in which:

FIG. 1 shows a ram air turbine (RAT);

FIG. 2A shows a schematic view of a typical linkage release mechanism in the locked position;

FIG. 2B shows the mechanism of FIG. 2A in the unlocked position;

FIGS. 3A and 3B show a schematic view of the piston, cylinder and spring arrangement of the actuator lock bolt, which would replace the conventional mechanism shown within the dashed lines of FIGS. 2A and 2B.

FIGS. 4A and 4B show the components of FIGS. 3A and 3B in a sectional view.

### DETAILED DESCRIPTION

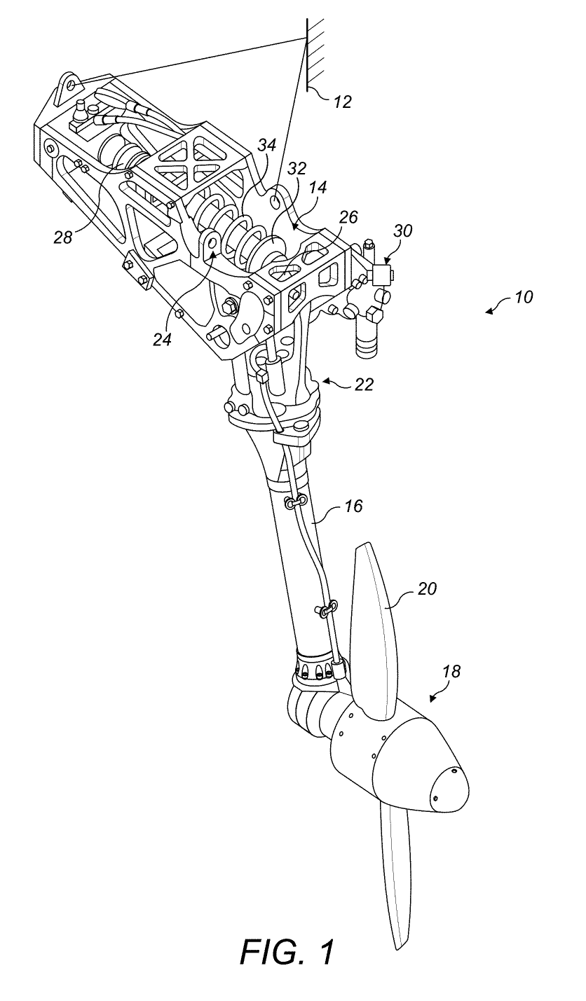

FIG. 1 shows a RAT system 10 which is secured to an aircraft structure 12 by housing 14. The housing 14 pivotally supports a strut 16 having a turbine 18 at one end. The turbine 18 includes blades 20 which impart rotational drive to a generator 22 and a hydraulic pump 30, for example. An actuator 24 is secured to the strut at a first end 26 and to the housing at a second end 28. The actuator 24 is illustrated in its deployed position. The actuator 24 comprises a cylinder 32 which is biased by a spring 34 in order to deploy the strut 16. When the cylinder 32 is retracted, it is held in its retracted position by means of a lock bolt of a locking mechanism, details of which will be described below.

The unlocking of the actuator is initiated by permitting movement of the lock bolt 38. This is made possible by means of a release mechanism according to the present disclosure which will be described further below.

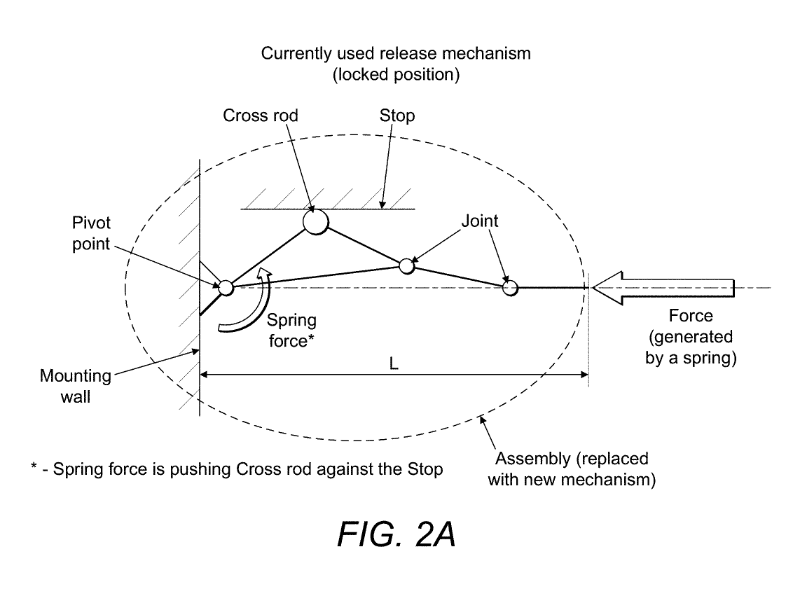

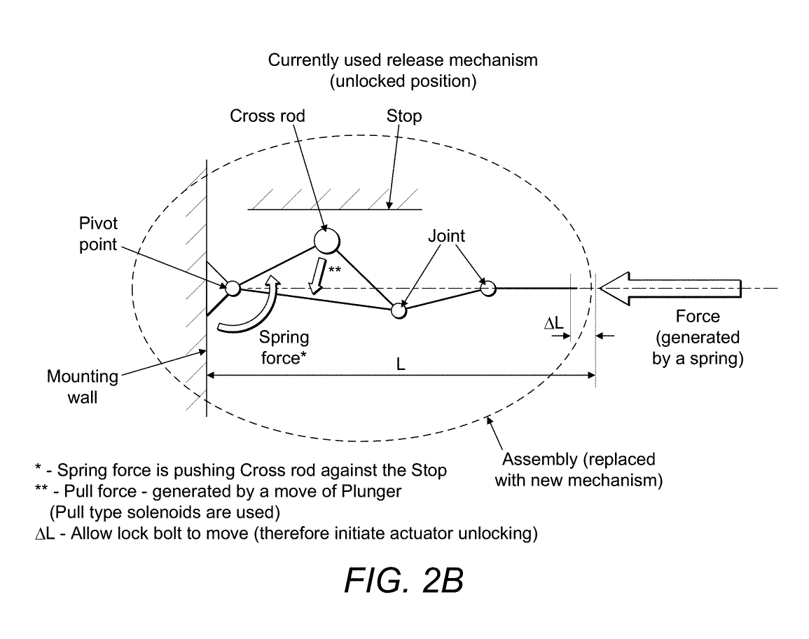

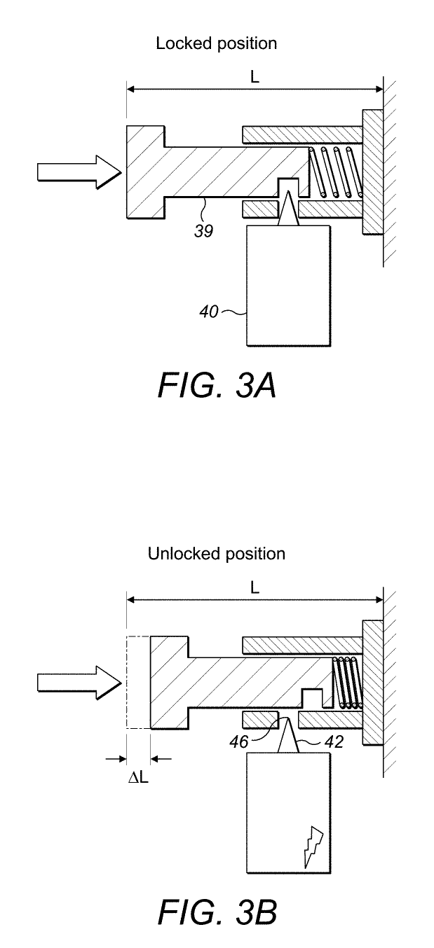

FIGS. 3A and 3B show a schematic view of the piston, cylinder and spring arrangement of the actuator lock bolt, and the release mechanism which would replace the conventional, linkage-type mechanism shown within the dashed lines of FIGS. 2A and 2B.

FIG. 3A shows the piston 39 in the locked position and, in FIG. 3B, in the unlocked position permitting movement of the piston 39 and the lock bolt for deployment of the actuator, this can be realised due to the fact that the lock bolt spring force is greater than the piston spring force.

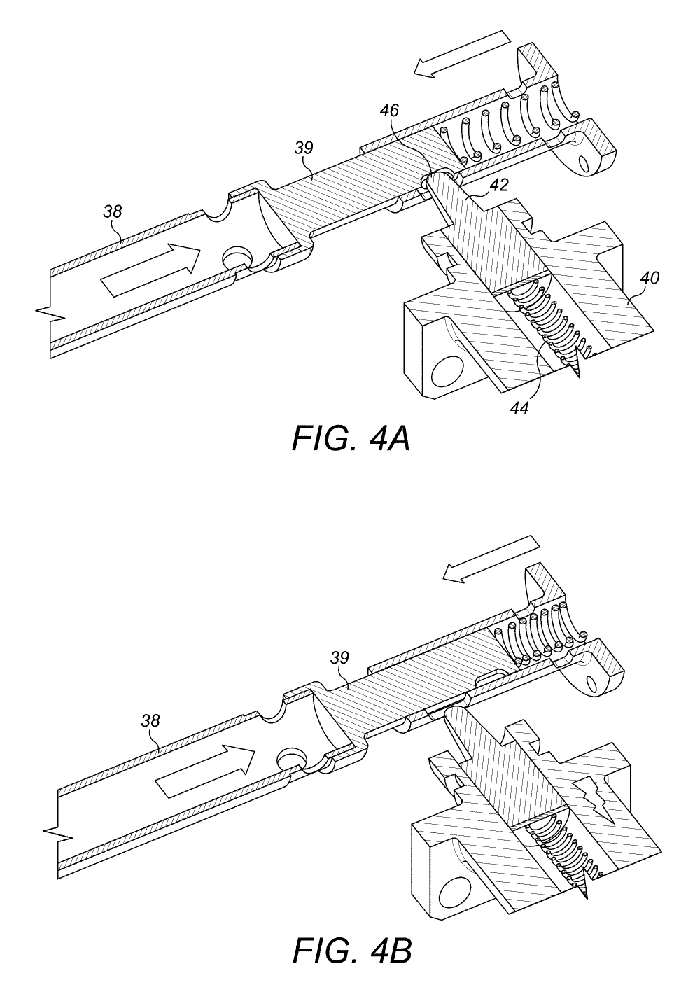

FIGS. 4A and 4B show the components of FIGS. 3A and 3B in a sectional view.

The release mechanism comprises a solenoid 40 having a solenoid plunger 42 and a solenoid bias spring 44, the solenoid plunger having a solenoid plunger tip 46 arranged to engage with the piston 39.

In the examples shown, when the solenoid is de-energised, the solenoid bias spring biases the solenoid plunger in an extended position in which the solenoid plunger tip extends into engagement with the piston, preferably engaging it in a recess or detent in or on the piston, to prevent axial movement of the lock bolt.

When the solenoid is energised (FIG. 4B), the solenoid plunger (which is ferromagnetic) retracts due to magnetic field force creation in the solenoid, therefore the solenoid biased spring contracts and, hence, draws the solenoid plunger tip out of engagement with the piston 39, thus permitting axial movement of the piston and the lock bolt 38, against the spring 34 force.

The example shown comprises a single solenoid. It is also possible to have two or perhaps even more solenoids arranged in parallel (or coaxially) to provide redundancy and extra engagement force. If two solenoids are used, the release mechanism reacts more quickly and meets the requirements of aviation regulations for the duplication of critical systems.

An alternative embodiment could have a push-type solenoid, rather than a pull-type solenoid, in which case the solenoid would be in the locked position when the solenoid was energised and in the unlocked position when the solenoid was de-energised.

The arrangement of the present release mechanism requires significantly fewer component parts as compared to the linkage system of the prior art, which, in turn, reduces the manufacturing, assembly and testing costs and avoids the need for shims as in the prior art systems. This can result in a more reliable and smaller deployment system, as smaller forces have to be overcome by the solenoid.

This mechanism could be easily adapted to existing actuators.

When the RAT is to be retracted to the stowed position, the lock bolt 38 is moved in the opposition direction, allowing the piston to slide in the same direction as the lock bolt until the solenoid plunger tip will jump into the recess or detent, preferably located on a piston side wall, locking it in position. This movement of the piston is realised by uncompressing (expanding) the supporting spring.

The above is a description of a single embodiment by way of example only. Modifications may be made without departing from the scope of this disclosure.

While the apparatus has been described in the context of unlocking a RAT actuator, it may, as mentioned above, find use in other applications, for example of the types of actuator, valves, pumps or the like.

1. A locking mechanism for releasably locking a lock bolt against axial movement, the mechanism comprising:
a solenoid assembly arranged, in use, in proximity to an axially moveable member, the solenoid assembly comprising a solenoid, a solenoid bias member and a solenoid plunger having a plunger tip, wherein when the solenoid is in a first state of either energised or not energised, the bias member causes the solenoid plunger to move to bring the plunger tip into locking engagement with the axially moveable member to prevent axial movement thereof together with the lock bolt, and when the solenoid is in a second, opposite state being the other of not energised or energised, the solenoid bias member causes the solenoid plunger to move to bring the plunger tip out of locking engagement with the axially moveable member thus permitting axial movement thereof together with the lock bolt.

2. The locking mechanism of claim 1, wherein, in the first state, the solenoid is not energised and in the second state, the solenoid is energised.

3. The locking mechanism of claim 1, wherein, in the first state, the solenoid is energised and in the second state, the solenoid is not energised.

4. The locking mechanism of claim 1, wherein said axially moveable member comprises a piston in moveable engagement with the lock bolt.

5. The locking mechanism of claim 1, wherein the solenoid bias member comprises a spring.

6. The locking mechanism of claim 1, wherein the mechanism comprises two such solenoid assemblies.

7. An actuator assembly comprising an axially moveable lock bolt; and a locking mechanism as claimed in claim 1.
